(19) United States
(12) Patent Application Publication
(10) Pub. No.: US 2004/0160114 A1
(43) Pub. Date: Aug. 19, 2004

(54) Adjustable wheel and method of making the same

(76) Inventor: Steven L. Seidner, Pomona, CA (US)

Correspondence Address: CHRISTIE, PARKER & HALE, LLP, PO BOX 7068, PASADENA, CA, 91109-7068, US

(21) Appl. No.: 10/776,073

(22) Filed: Feb. 11, 2004

Related U.S. Application Data
(60) Provisional application No. 60/447,660, filed on Feb. 14, 2003.

(51) Int. Cl. B60B 3/10

(52) U.S. Cl. 301/64.101

(57) ABSTRACT

A wheel comprising a wheel blank and at least one design element, wherein the at least one design element is a separate part attached to the wheel blank. The wheel may further comprise an outer peripheral portion, an inner hub portion and an intermediate portion bridging the other peripheral portion and the inner hub portion. Additionally, the design element may be made from aluminum, may be a different color than the wheel blank and may have a different finish than the wheel blank.

### CROSS-REFERENCE TO RELATED APPLICATION

This application claims priority of provisional application Serial No. 60/447,660 filed Feb. 14, 2003

### BACKGROUND OF THE INVENTION

The present invention relates to a wheel for a vehicle and a method of manufacturing the same. In particular, the invention relates to a wheel for a motorcycle, wherein a design or shape is created on the wheel, which design or shape may be more complex than previously possible and may be adjustable.

Wheels are often manufactured from wheel blanks. A wheel blank is a disk having an outer peripheral portion, an inner hub portion and an intermediate portion bridging the outer peripheral portion and the inner hub portion. The outer peripheral portion may extend generally perpendicular from the intermediate disk portion. The inner hub portion may also extend generally perpendicular from the intermediate disk portion, forming a plateau in the center of the wheel blank. For some vehicles, where a wheel will be seen from both sides, such as a motorcycle, the wheel blanks for such vehicles have opposed side surfaces that are symmetrical to one another.

The wheel blank may then be machined into a wheel. First, holes through which means for attaching the wheel to a vehicle frame may be drilled through both sides of the inner hub portion. Further, designs may be created in the intermediate portion of the blank by machining out holes in various shapes. In addition to holes, crevices, grooves or other indentations may be machined into the intermediate portion to create more intricate designs. The machined wheel blank may then be painted or chrome plated to finish the wheel. The indentations may be painted a different color from the wheel base to enhance certain aspects of the design, or they may be the same color as the wheel base color.

While machining wheel blanks as described above allows for some creativity, it does not easily allow for complicated designs or for changes or edits to a design that involve increasing surface area once a blank has been machined. It is also difficult to provide a two-tone or multi-tone color scheme for complicated shapes on a wheel design, or to combine chrome-plated and painted design elements. Attempting complicated finishes, if even possible, is also a costly procedure. Finally, due to the relatively two-dimensional nature of machining wheel blanks, it is difficult to make undercuts, hollow out large areas of the wheel blank or otherwise provide three-dimensional effects.

### SUMMARY

In one embodiment, the present invention provides a wheel where the design on the wheel may have an increased complexity and/or surface area. In that or other embodiments, the present invention provides a wheel that may not have to be remachined in order to change or edit the design, and provides a wheel that may allow for undercuts, hollow areas or other three-dimensional effects in a design. Finally, embodiments of the present invention may provide a wheel that allows for a two-tone or multi-tone color scheme that is easy and inexpensive to create, even for complicated or intricate designs.

### BRIEF DESCRIPTION OF THE DRAWINGS

FIG. 1 is a diagrammatic side view of an exemplary embodiment of the present invention.

FIG. 2 is a diagrammatic view of an exemplary design plate of the present invention.

FIG. 3 is diagrammatic side view of another exemplary embodiment of the invention.

FIG. 4 is diagrammatic side view of another exemplary embodiment of the invention.

### DETAILED DESCRIPTION OF THE INVENTION

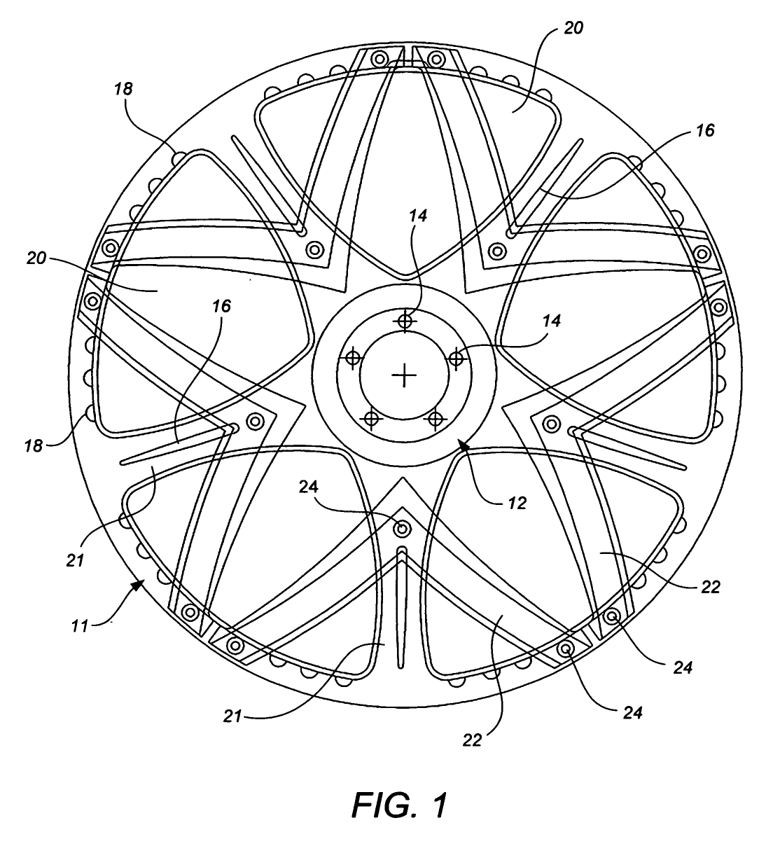

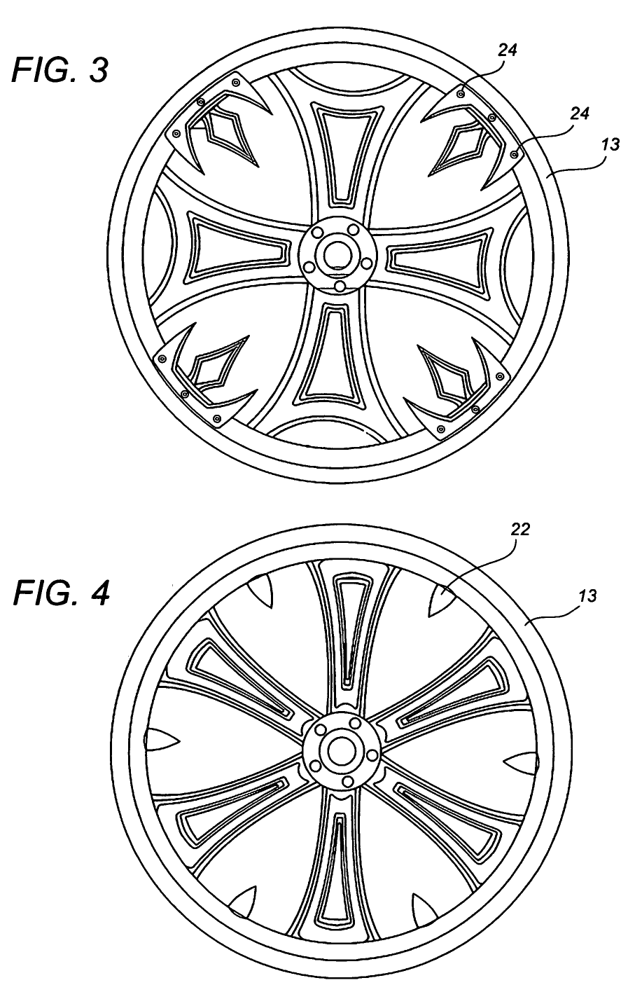

FIG. 1 shows a diagrammatic side view of an exemplary embodiment of the present invention. The wheel blank 10 may be formed so as to comprise an outer peripheral portion 13 (as shown in FIG. 3), an inner hub portion 12 and an intermediate portion bridging the outer peripheral portion 13 and the inner hub portion 12. Wheel blanks may be manufactured from any suitable material, but typically the blanks are cast aluminum. Wheel blanks may also be made from steel. Located within the inner hub portion 12 are holes 14 through which means for attaching the wheel to a vehicle frame may be passed. Such holes are typically drilled into the cast blank.

As shown in the exemplary embodiment of FIG. 1, large sections 20 of the original wheel blank have been cut out so that the remaining sections form spokes 21. The sections 20 may be cut out using computer controlled machining, or other such methods suitable to accomplish the desired effect. A wide variety of sized or shaped holes may be cut into the intermediate section depending on the base design desired. Additionally, the intermediate portion may be left entirely intact if so desired. In addition to the large sections 20 that may be entirely removed from the wheel blank, crevices 18, grooves 16 or other indentations or design elements may be machined into the wheel blank.

For motorcycle wheels, each side surface is typically machined out in a symmetrical pattern so that the wheel will look the same from either side. However, the side surfaces need not be symmetrical and, for vehicles where both sides of the wheel are not visible, the side surfaces will typically not be symmetrical. The present invention is applicable to situations where designs are symmetrical or asymmetrical and where one or both sides of a wheel have a design.

In addition to the base design of the wheel blank, holes may be drilled into the blank in order to bolt on, rivet on or otherwise attach additional design elements. These elements may be designed in a variety of shapes, sizes, textures and colors and may allow the design to be more intricate or ornate than would be reasonably possible or economical to achieve with computer controlled machining alone. The design elements may be attached to the blank by inserting bolts through holes in the design elements and into threaded holes that have been drilled into the wheel blank, or by other appropriate means. If bolts are used, the bolts may have hex heads, slot heads, phillips heads, allen heads or other means allowing them to be driven into the threaded holes in the blank. The holes in the design elements may also have a counterbore or other means to allow the bolt to be driven into a recessed position or a position flush with the surfaces of the design element.

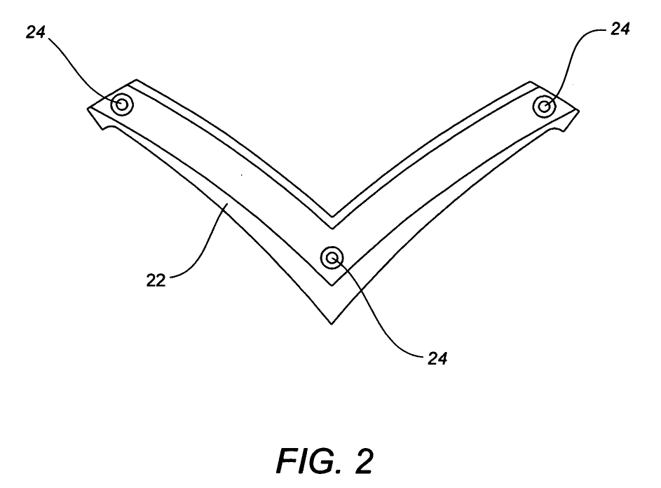

In a further exemplary embodiment of the present invention, the design elements for a wheel may comprise machined plates 22. Plates 22 may be machined into any desired shape and may be the same or a different color from the wheel blank base color. In FIG. 2, for example, the plates 22 are shown to be generally V-shaped, in FIG. 3, the plates are shown to be a more intricate U or W shape and in FIG. 4, the plates are a more simple spearhead shape. Further, plates 22 do not all have to be the same shape, but rather may be used in combinations of any size and shape. Plates 22 may be manufactured from any suitable material, but typically the plates are cast aluminum. The plates and other design elements may also be machined or stamped from steel.

Plates 22, as with other possible design elements, may be attached to wheel blank 10 by any means sufficient to securely attach the plates 22 to the blank 10, but also to allow the plates to be relatively easily removed if so desired. One means for attaching plates 22 to blank 10 is by a screw or bolt 24. Threaded holes (not shown) may be drilled into any portion of the blank to provide a means for attaching the plates 22 to the blank 10. The number of holes permitted is limited only by the amount of the intermediate portion left after initial machining and the amount of structural support desired to be provided by the wheel. When bolts 24 are inserted into the holes to attach plates 22 to wheel blank 10, an adequate amount of a high strength threadlocker may be applied to the threads of the screw to more securely hold the plates 22 to the wheel blank 10. A high strength threadlocker or other appropriate adhesive allows the screws to remain in place despite vibration during the use of the wheel, yet still allows for their removal as necessary with an appropriate device such as a wrench or screwdriver. An example of an applicable high strength threadlocker is LOCTITE® manufactured by Loctite Corp. of Rocky Hill, Conn.

Removability of the plates 22 allows for plates creating different designs to be easily interchanged with existing plates. After they are designed, the plates 22 may be painted, chrome-plated and/or textured as desired. Having the plates 22 separable from the base design allows for ease of initial coloring as no masking of the base design is necessary. Additionally, plates 22 may be removed, painted a different color and reattached. The same flexibility can also be achieved with design elements other than plates to allow for a great deal of customization and originality in creating wheel designs.

It should be understood that the specific embodiments of the present invention described above may be modified or revised without departing from the spirit of the present invention. For example, any number, size and shaped plates may be attached to the wheel. Accordingly, the present invention should not be viewed as limited by those embodiments but rather, its scope should be viewed as set forth in the following claims.

We claim:

1. A wheel comprising:
a wheel blank and
at least one design element,
wherein the at least one design element is a separate part attached to the wheel blank.

2. The wheel of claim 1 wherein the wheel blank further comprises an outer peripheral portion, an inner hub portion and an intermediate portion bridging the outer peripheral portion and the inner hub portion.

3. The wheel of claim 2 wherein the at least one design element is attached to the wheel blank of the intermediate portion.

4. The wheel of claim 1 wherein the wheel blank is made from aluminum.

5. The wheel of claim 1 wherein the wheel blank is made from steel.

6. The wheel of claim 1 wherein the at least one design element is a different color than the wheel blank.

7. The wheel of claim 1 wherein the at least one design element has a different finish than the wheel blank.

8. The wheel of claim 1 wherein the at least one design element has a different surface texture than the wheel blank.

9. The wheel of claim 1 wherein the at least one design element is attached to the wheel blank by screws.

10. The wheel of claim 9 wherein an adhesive is applied to the screws prior to attaching the screws to the wheel blank.

11. The wheel of claim 10 wherein the adhesive is a high strength threadlocker.

12. The wheel of claim 1 wherein the at least one design element is made from aluminum.

13. The wheel of claim 1 wherein the at least one design element is made from steel.

14. The wheel of claim 1 wherein the at least one design element is a shaped plate.

15. The wheel of claim 1 wherein the at least one design element is removably attached to the wheel blank.

16. A wheel comprising:
a wheel blank having an outer peripheral portion, an inner hub portion and an intermediate portion bridging the outer peripheral portion and the inner hub portion, and
at least one plate,
wherein the at least one plate is removably attached to the wheel blank at the intermediate portion by screws, and
wherein the at least one plate is a different from the wheel blank in at least one of the properties color, finish and surface texture.

17. A wheel comprising:
a wheel blank having a design and
means for altering the design of the wheel blank by addition of at least one design element without remachining the wheel blank
wherein such altering means are separate and attached to the wheel blank.
